(19) United States
(12) Patent Application Publication
(10) Pub. No.: US 2018/0048915 A1
(43) Pub. Date: Feb. 15, 2018

(54) METHOD AND APPARATUS FOR ENCODING/DECODING A VIDEO SIGNAL

(71) Applicant: LG Electronics Inc., Seoul (KR)

(72) Inventors: Yongjoon JEON, Seoul (KR); Jin HEO, Seoul (KR); Sunmi YOO, Seoul (KR); Seungwook PARK, Seoul (KR)

(21) Appl. No.: 15/553,975

(22) PCT Filed: Nov. 24, 2015
(86) PCT No.: PCT/KR2015/012648

§ 371 Date: Aug. 25, 2017

Related U.S. Application Data
(60) Provisional application No. 62/141,243, filed on Mar. 31, 2015.
(60) Provisional application No. 62/132,513, filed on Mar. 13, 2015.
(60) Provisional application No. 62/121,517, filed on Feb. 27, 2015.

(51) Int. Cl. H04N 19/61; H04N 19/44; H04N 19/105; H04N 19/70; H04N 19/176; H04N 19/107

(52) U.S. Cl. CPC H04N 19/61; H04N 19/176; H04N 19/107; H04N 19/105; H04N 19/70; H04N 19/45

(57) ABSTRACT

A method for encoding a video signal includes determining a dominant prediction direction of a current block using information of a neighboring block; determining a number of intra prediction modes to transmit based on the dominant prediction direction; determining an optimal intra prediction mode based on the number of intra prediction modes; and generating a prediction signal according to the optimal intra prediction mode.

### TECHNICAL FIELD

The present invention relates to a method and apparatus for encoding/decoding a video signal, and more particularly, to a method and apparatus for performing an intra prediction adaptively.

### BACKGROUND ART

Compression encoding means a series of signal processing technology for transmitting digitalized information through a communication line or for storing digitalized information in a form appropriate to a storage medium. Media such video, an image, and a voice may be a target of compression encoding, particularly, technology that performs compression encoding using video as a target is referred to as video compression.

Next generation video contents will have a characteristic of a high spatial resolution, a high frame rate, and high dimensionality of scene representation. In order to process such contents, memory storage, memory access rate, and processing power technologies will remarkably increase.

Therefore, it is necessary to design a coding tool for more efficiently processing next generation video contents.

Particularly, in the case of an intra prediction, it is hard to predict images of various shapes more accurately owing to a mode configuration of a predetermined degree of precision.

### DISCLOSURE

### Technical Problem

An object of the present invention is to propose a method enables to configure an intra prediction mode adaptively according to a property of an image when performing an intra prediction.

Another object of the present invention is to propose a method that enables to adaptively select at least one of the number of modes or the position of each mode that corresponds to an intra angular mode.

Another object of the present invention is to propose a method for transmitting an adaptive intra prediction mode.

Another object of the present invention is to propose a method for transmitting the number of prediction directions when performing an intra prediction.

Another object of the present invention is to propose a method for deriving the number of prediction directions when performing an intra prediction.

Another object of the present invention is to propose a method for configuring a group index when performing an intra prediction.

Another object of the present invention is to propose a method for determining an intra prediction mode based on a group index.

### Technical Solution

The present invention provides a method that enables to configure an intra prediction mode adaptively based on a property of an image.

The present invention provides a method for selecting an adaptive intra prediction mode from a context signal.

The present invention provides a method for transmitting an adaptive intra prediction mode.

The present invention provides a method for signaling by defining syntax with respect to the number of prediction directions.

The present invention provides a method for deriving the number of prediction directions from a specific parameter.

The present invention provides a method for configuring a group index based on a prediction direction.

The present invention provides a method for determining an intra prediction mode based on a group index.

### Technical Effects

According to the present invention, an intra prediction mode is adaptively configured according to a property of an image adaptively, and accordingly, an intra prediction may be performed more efficiently.

In addition, according to the present invention, by performing an adaptive intra prediction, an amount of data of a residual signal generated when encoding a video image may be decreased, thereby processing a video signal more efficiently.

In addition, according to the present invention, when a coding unit includes a plurality of prediction units, each prediction unit may have an intra prediction mode adaptively, thereby performing an intra prediction in more detail.

In addition, according to the present invention, a dominant prediction direction of a current block may be determined by defining a group index, and more efficient binarization may be performed by allocating shorter bit with respect to the dominant prediction direction.

In addition, according to the present invention, when a prediction block is generated, more accurate prediction block may be generated according to the reference pixel position determined by a prediction mode, and accordingly, an amount of data of a residual signal may be decreased, as a result, an amount of energy for transmitting it may be decreased.

### DESCRIPTION OF DRAWINGS

FIG. 1 is a block diagram illustrating a configuration of an encoder for encoding a video signal according to an embodiment of the present invention.

FIG. 2 is a block diagram illustrating a configuration of a decoder for decoding a video signal according to an embodiment of the present invention.

FIG. 3 is a diagram illustrating a division structure of a coding unit according to an embodiment of the present invention.

FIG. 4 is an embodiment to which the present invention is applied and is a diagram for illustrating a prediction unit.

FIG. 5 is a diagram for describing an intra prediction method, as an embodiment to which the present invention is applied.

FIG. 6 is a diagram for describing a prediction direction according to an intra prediction mode, as an embodiment to which the present invention is applied.

FIG. 7 is a diagram for describing a selection of mode adaptively in the case of 1/M degree of precision in the intra prediction mode, as an embodiment to which the present invention is applied.

FIG. 8 is a diagram for describing the number of prediction directions and the number of modes in the intra prediction modes.

FIG. 9 illustrates various method of selection L modes based on a dominant direction in the intra prediction mode, as an embodiment to which the present invention is applied.

FIG. 10 is a schematic block diagram of an encoder that encodes an adaptively selected mode in the intra prediction, as an embodiment to which the present invention is applied.

FIG. 11 illustrates a schematic block diagram of a decoder for decoding a mode adaptively selected in the intra prediction, as an embodiment to which the present invention is applied.

FIG. 12 illustrates various methods for the L numbers of intra prediction modes selected based on the dominant direction, as an embodiment to which the present invention is applied.

FIG. 13 is a diagram for describing a method of selecting the dominant direction using a neighboring sample, as an embodiment to which the present invention is applied.

FIG. 14 is a diagram for describing a method of selecting the dominant direction using neighboring mode information, as an embodiment to which the present invention is applied.

FIG. 15 illustrates a syntax structure for transmitting the number of prediction directions, as an embodiment to which the present invention is applied.

FIG. 16 is a diagram for describing a method for configuring a group index with respect to an intra prediction mode, as an embodiment to which the present invention is applied.

FIGS. 17 and 18 are diagrams for describing a method for determining a dominant prediction direction based on a group index of a neighboring block, as an embodiment to which the present invention is applied.

FIGS. 19 and 20 are flowcharts for describing a method for allocating a prediction mode based on a group index of a neighboring block, as an embodiment to which the present invention is applied.

FIGS. 21 and 22 are schematic block diagrams of an encoder and a decoder for remapping a mode according to a dominant direction flag, as an embodiment to which the present invention is applied.

FIG. 23 illustrates a syntax structure for configuring a dominant direction flag based on a group index of a neighboring block, as an embodiment to which the present invention is applied.

FIG. 24 illustrates a syntax structure for deriving a bit number with respect to mode information based on a dominant direction flag, as an embodiment to which the present invention is applied.

FIG. 25 illustrates a syntax structure for remapping a mode based on at least one of a dominant direction flag and a group index, as an embodiment to which the present invention is applied.

### BEST MODE FOR INVENTION

The present invention provides a method for encoding a video signal including determining a dominant prediction direction of a current block using information of a neighboring block; determining a number of intra prediction modes to transmit based on the dominant prediction direction; determining an optimal intra prediction mode based on the number of intra prediction modes; and generating a prediction signal according to the optimal intra prediction mode.

In addition, the present invention further includes obtaining the information of the neighboring block, and the information of the neighboring block includes at least one of group index information, an intra prediction mode or edge information.

In addition, the present invention further includes checking whether group index information of the neighboring block is identical, and the dominant prediction direction is determined according to the group index information of the neighboring block.

In addition, the present invention further includes checking whether the intra prediction mode of the neighboring block is identical, and the dominant prediction direction is determined according to the intra prediction mode of the neighboring block.

In addition, the present invention further includes checking whether the edge information of the neighboring block is detected, and the dominant prediction direction is determined according to the edge information of the neighboring block.

In addition, in the present invention, the neighboring block includes a left block and an upper block neighboring to the current block.

In addition, the present invention further includes deriving a variable representing whether the dominant prediction direction is existed; and remapping the optimal intra prediction mode based on the variable.

In addition, in the present invention, the information of the neighboring block includes at least one of group index information, an intra prediction mode or edge information, and the optimal intra prediction mode is remapped based on the group index information and the variable.

In addition, the present invention provides a method for decoding a video signal including determining a dominant prediction direction of a current block using information of a neighboring block; deriving a variable representing whether the dominant prediction direction is existed; remapping an intra prediction mode extracted from the video signal based on the variable; and generating a prediction signal according to the remapped intra prediction mode.

In addition, the present invention further includes obtaining the information of the neighboring block, and the information of the neighboring block includes at least one of group index information, an intra prediction mode or edge information.

In addition, the present invention further includes checking whether group index information of the neighboring block is identical, and the dominant prediction direction is determined according to the group index information of the neighboring block.

In addition, the present invention provides an apparatus for encoding a video signal including a prediction direction deriving unit configured to determine a dominant prediction direction of a current block using information of a neighboring block, and to determine a number of intra prediction modes to transmit based on the dominant prediction direction; and an intra prediction unit configured to determine an optimal intra prediction mode based on the number of intra prediction modes, and to generate a prediction signal according to the optimal intra prediction mode.

In addition, in the present invention, the prediction direction deriving unit obtains the information of the neighboring block, and the information of the neighboring block includes at least one of group index information, an intra prediction mode or edge information.

In addition, in the present invention, the prediction direction deriving unit checks whether group index information of the neighboring block is identical, and the dominant prediction direction is determined according to the group index information of the neighboring block.

In addition, in the present invention, the prediction direction deriving unit derives a variable representing whether the dominant prediction direction is existed, and the apparatus further includes a mode remapping unit configured to remap the optimal intra prediction mode based on the variable.

In addition, the present invention provides an apparatus for decoding a video signal including a prediction direction deriving unit configured to determine a dominant prediction direction of a current block using information of a neighboring block, and to derive a variable representing whether the dominant prediction direction is existed; a mode remapping unit configured to remap an intra prediction mode extracted from the video signal based on the variable; and an intra prediction unit configured to generate a prediction signal according to the remapped intra prediction mode.

### MODE FOR INVENTION

Hereinafter, a configuration and operation of an embodiment of the present invention will be described in detail with reference to the accompanying drawings, a configuration and operation of the present invention described with reference to the drawings are described as an embodiment, and the scope, a core configuration, and operation of the present invention are not limited thereto.

Further, terms used in the present invention are selected from currently widely used general terms, but in a specific case, randomly selected terms by an applicant are used. In such a case, in a detailed description of a corresponding portion, because a meaning thereof is clearly described, the terms should not be simply construed with only a name of terms used in a description of the present invention and a meaning of the corresponding term should be comprehended and construed.

Further, when there is a general term selected for describing the invention or another term having a similar meaning, terms used in the present invention may be replaced for more appropriate interpretation. For example, in each coding process, a signal, data, a sample, a picture, a frame, and a block may be appropriately replaced and construed. Further, in each coding process, partitioning, decomposition, splitting, and division may be appropriately replaced and construed.

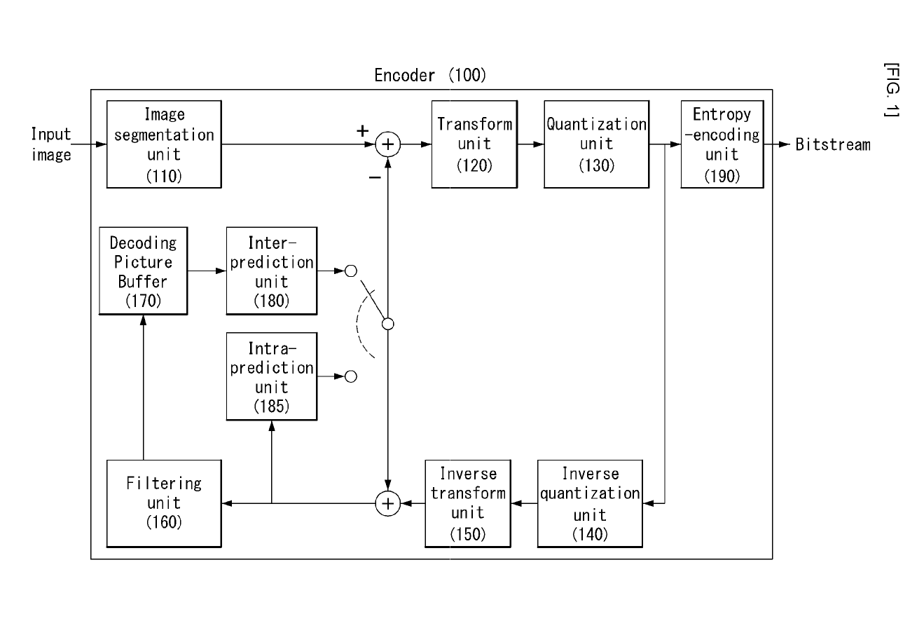

FIG. 1 shows a schematic block diagram of an encoder for encoding a video signal, in accordance with one embodiment of the present invention.

Referring to FIG. 1, an encoder 100 may include an image segmentation unit 110, a transform unit 120, a quantization unit 130, an inverse quantization unit 140, an inverse transform unit 150, a filtering unit 160, a DPB (Decoded Picture Buffer) 170, an inter-prediction unit 180, an intra-prediction unit 185 and an entropy-encoding unit 190.

The image segmentation unit 110 may divide an input image (or, a picture, a frame) input to the encoder 100 into one or more process units. For example, the process unit may be a coding tree unit (CTU), a coding unit (CU), a prediction unit (PU), or a transform unit (TU).

However, the terms are used only for convenience of illustration of the present disclosure, the present invention is not limited to the definitions of the terms. In this specification, for convenience of illustration, the term “coding unit” is employed as a unit used in a process of encoding or decoding a video signal, however, the present invention is not limited thereto, another process unit may be appropriately selected based on contents of the present disclosure.

The encoder 100 may generate a residual signal by subtracting a prediction signal output from the inter-prediction unit 180 or intra prediction unit 185 from the input image signal. The generated residual signal may be transmitted to the transform unit 120.

The transform unit 120 may apply a transform technique to the residual signal to produce a transform coefficient. The transform process may be applied to a pixel block having the same size of a square, or to a block of a variable size other than a square.

The quantization unit 130 may quantize the transform coefficient and transmits the quantized coefficient to the entropy-encoding unit 190. The entropy-encoding unit 190 may entropy-code the quantized signal and then output the entropy-coded signal as bitstreams.

The quantized signal output from the quantization unit 130 may be used to generate a prediction signal. For example, the quantized signal may be subjected to an inverse quantization and an inverse transform via the inverse quantization unit 140 and the inverse transform unit 150 in the loop respectively to reconstruct a residual signal. The reconstructed residual signal may be added to the prediction signal output from the inter-prediction unit 180 or intra-prediction unit 185 to generate a reconstructed signal.

On the other hand, in the compression process, adjacent blocks may be quantized by different quantization parameters, so that deterioration of the block boundary may occur. This phenomenon is called blocking artifacts. This is one of important factors for evaluating image quality. A filtering process may be performed to reduce such deterioration. Using the filtering process, the blocking deterioration may be eliminated, and, at the same time, an error of a current picture may be reduced, thereby improving the image quality.

The filtering unit 160 may apply filtering to the reconstructed signal and then outputs the filtered reconstructed signal to a reproducing device or the decoded picture buffer 170. The filtered signal transmitted to the decoded picture buffer 170 may be used as a reference picture in the inter-prediction unit 180. In this way, using the filtered picture as the reference picture in the inter-picture prediction mode, not only the picture quality but also the coding efficiency may be improved.

The decoded picture buffer 170 may store the filtered picture for use as the reference picture in the inter-prediction unit 180.

The inter-prediction unit 180 may perform temporal prediction and/or spatial prediction with reference to the reconstructed picture to remove temporal redundancy and/or spatial redundancy. In this case, the reference picture used for the prediction may be a transformed signal obtained via the quantization and inverse quantization on a block basis in the previous encoding/decoding. Thus, this may result in blocking artifacts or ringing artifacts.

Accordingly, in order to solve the performance degradation due to the discontinuity or quantization of the signal, the inter-prediction unit 180 may interpolate signals between pixels on a subpixel basis using a low-pass filter. In this case, the subpixel may mean a virtual pixel generated by applying an interpolation filter. An integer pixel means an actual pixel existing in the reconstructed picture. The interpolation method may include linear interpolation, bi-linear interpolation and Wiener filter, etc.

The interpolation filter may be applied to the reconstructed picture to improve the accuracy of the prediction. For example, the inter-prediction unit 180 may apply the interpolation filter to integer pixels to generate interpolated pixels. The inter-prediction unit 180 may perform prediction using an interpolated block composed of the interpolated pixels as a prediction block.

The intra-prediction unit 185 may predict a current block by referring to samples in the vicinity of a block to be encoded currently. The intra-prediction unit 185 may perform a following procedure to perform intra prediction. First, the intra-prediction unit 185 may prepare reference samples needed to generate a prediction signal. Then, the intra-prediction unit 185 may generate the prediction signal using the prepared reference samples. Thereafter, the intra-prediction unit 185 may encode a prediction mode. At this time, reference samples may be prepared through reference sample padding and/or reference sample filtering. Since the reference samples have undergone the prediction and reconstruction process, a quantization error may exist. Therefore, in order to reduce such errors, a reference sample filtering process may be performed for each prediction mode used for intra-prediction.

The prediction signal generated via the inter-prediction unit 180 or the intra-prediction unit 185 may be used to generate the reconstructed signal or used to generate the residual signal.

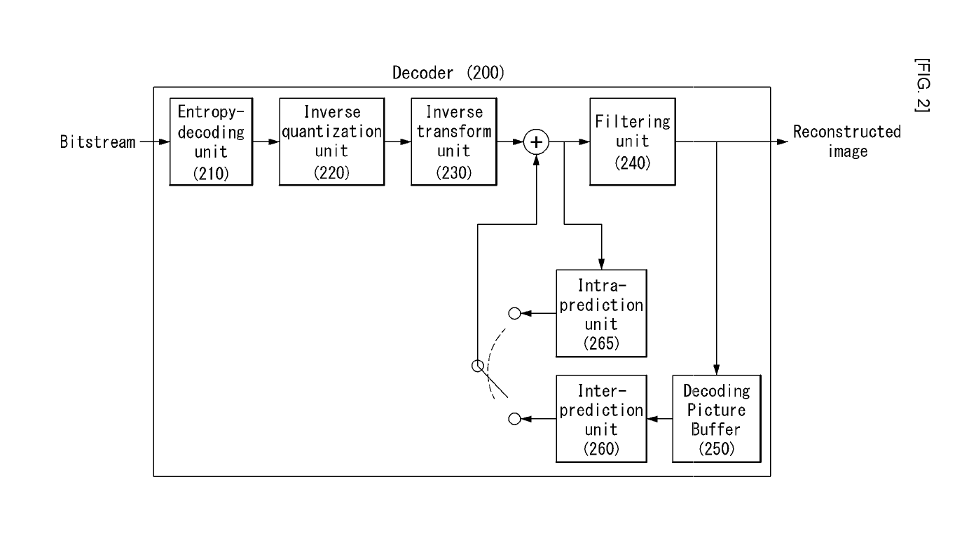

FIG. 2 shows a schematic block diagram of a decoder for decoding a video signal, in accordance with one embodiment of the present invention.

Referring to FIG. 2, a decoder 200 may include an entropy-decoding unit 210, an inverse quantization unit 220, an inverse transform unit 230, a filtering unit 240, a decoded picture buffer (DPB) 250, an inter-prediction unit 260 and an intra-prediction unit 265.

A reconstructed video signal output from the decoder 200 may be reproduced using a reproducing device.

The decoder 200 may receive the signal output from the encoder as shown in FIG. 1. The received signal may be entropy-decoded via the entropy-decoding unit 210.

The inverse quantization unit 220 may obtain a transform coefficient from the entropy-decoded signal using quantization step size information.

The inverse transform unit 230 may inverse-transform the transform coefficient to obtain a residual signal.

A reconstructed signal may be generated by adding the obtained residual signal to the prediction signal output from the inter-prediction unit 260 or the intra-prediction unit 265.

The filtering unit 240 may apply filtering to the reconstructed signal and may output the filtered reconstructed signal to the reproducing device or the decoded picture buffer unit 250. The filtered signal transmitted to the decoded picture buffer unit 250 may be used as a reference picture in the inter-prediction unit 260.

Herein, detailed descriptions for the filtering unit 160, the inter-prediction unit 180 and the intra-prediction unit 185 of the encoder 100 may be equally applied to the filtering unit 240, the inter-prediction unit 260 and the intra-prediction unit 265 of the decoder 200 respectively.

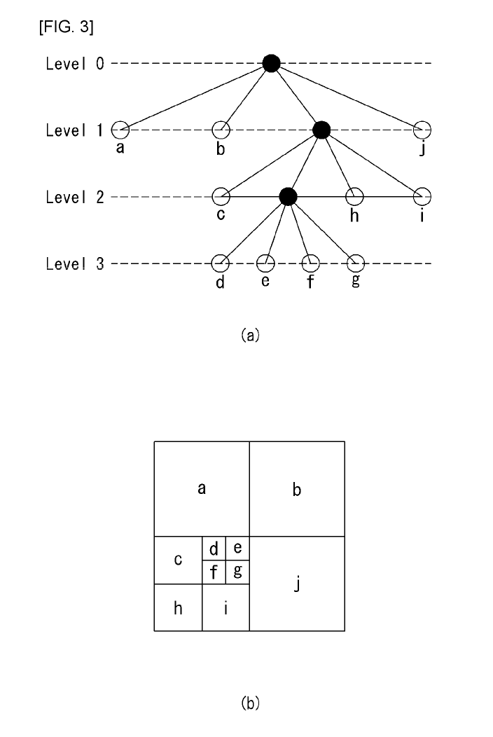

FIG. 3 is a diagram illustrating a division structure of a coding unit according to an embodiment of the present invention.

The encoder may split one video (or picture) in a coding tree unit (CTU) of a quadrangle form. The encoder sequentially encodes by one CTU in raster scan order.

For example, a size of the CTU may be determined to any one of 64×64, 32×32, and 16×16, but the present invention is not limited thereto. The encoder may select and use a size of the CTU according to a resolution of input image or a characteristic of input image. The CTU may include a coding tree block (CTB) of a luma component and a coding tree block (CTB) of two chroma components corresponding thereto.

One CTU may be decomposed in a quadtree (hereinafter, referred to as ‘QT’) structure. For example, one CTU may be split into four units in which a length of each side reduces in a half while having a square form. Decomposition of such a QT structure may be recursively performed.

Referring to FIG. 3, a root node of the QT may be related to the CTU. The QT may be split until arriving at a leaf node, and in this case, the leaf node may be referred to as a coding unit (CU).

The CU may mean a basic unit of a processing process of input image, for example, coding in which intra/inter prediction is performed. The CU may include a coding block (CB) of a luma component and a CB of two chroma components corresponding thereto. For example, a size of the CU may be determined to any one of 64×64, 32×32, 16×16, and 8×8, but the present invention is not limited thereto, and when video is high resolution video, a size of the CU may further increase or may be various sizes.

Referring to FIG. 3, the CTU corresponds to a root node and has a smallest depth (i.e., level 0) value. The CTU may not be split according to a characteristic of input image, and in this case, the CTU corresponds to a CU.

The CTU may be decomposed in a QT form and thus subordinate nodes having a depth of a level 1 may be generated. In a subordinate node having a depth of a level 1, a node (i.e., a leaf node) that is no longer split corresponds to the CU. For example, as shown in FIG. 3B, CU(a), CU(b), and CU(j) corresponding to nodes a, b, and j are split one time in the CTU and have a depth of a level 1.

At least one of nodes having a depth of a level 1 may be again split in a QT form. In a subordinate node having a depth of a level 2, a node (i.e., a leaf node) that is no longer split corresponds to a CU. For example, as shown in FIG. 3B, CU(c), CU(h), and CU(i) corresponding to nodes c, h, and I are split twice in the CTU and have a depth of a level 2.

Further, at least one of nodes having a depth of a level 2 may be again split in a QT form. In a subordinate node having a depth of a level 3, a node (i.e., a leaf node) that is no longer split corresponds to a CU. For example, as shown in FIG. 3B, CU(d), CU(e), CU(f), and CU(g) corresponding to d, e, f, and g are split three times in the CTU and have a depth of a level 3.

The encoder may determine a maximum size or a minimum size of the CU according to a characteristic (e.g., a resolution) of video or in consideration of encoding efficiency. Information thereof or information that can derive this may be included in bitstream. A CU having a maximum size may be referred to as a largest coding unit (LCU), and a CU having a minimum size may be referred to as a smallest coding unit (SCU).

Further, the CU having a tree structure may be hierarchically split with predetermined maximum depth information (or maximum level information). Each split CU may have depth information. Because depth information represents the split number and/or a level of the CU, the depth information may include information about a size of the CU.

Because the LCU is split in a QT form, when using a size of the LCU and maximum depth information, a size of the SCU may be obtained. Alternatively, in contrast, when using a size of the SCU and maximum depth information of a tree, a size of the LCU may be obtained.

For one CU, information representing whether a corresponding CU is split may be transferred to the decoder. For example, the information may be defined to a split flag and may be represented with “split_cu_flag”. The split flag may be included in the entire CU, except for the SCU. For example, when a value of the split flag is ‘1’, a corresponding CU is again split into four CUs, and when a value of the split flag is ‘0’, a corresponding CU is no longer split and a coding process of the corresponding CU may be performed.

In an embodiment of FIG. 3, a split process of the CU is exemplified, but the above-described QT structure may be applied even to a split process of a transform unit (TU), which is a basic unit that performs transform.

The TU may be hierarchically split in a QT structure from a CU to code. For example, the CU may correspond to a root node of a tree of the transform unit (TU).

Because the TU is split in a QT structure, the TU split from the CU may be again split into a smaller subordinate TU. For example, a size of the TU may be determined to any one of 32×32, 16×16, 8×8, and 4×4, but the present invention is not limited thereto, and when the TU is high resolution video, a size of the TU may increase or may be various sizes.

For one TU, information representing whether a corresponding TU is split may be transferred to the decoder. For example, the information may be defined to a split transform flag and may be represented with a “split_transform_flag”.

The split transform flag may be included in entire TUs, except for a TU of a minimum size. For example, when a value of the split transform flag is ‘1’, a corresponding TU is again split into four TUs, and a value of the split transform flag is ‘0’, a corresponding TU is no longer split.

As described above, the CU is a basic unit of coding that performs intra prediction or inter prediction. In order to more effectively code input image, the CU may be split into a prediction unit (PU).

A PU is a basic unit that generates a prediction block, and a prediction block may be differently generated in a PU unit even within one CU. The PU may be differently split according to whether an intra prediction mode is used or an inter prediction mode is used as a coding mode of the CU to which the PU belongs.

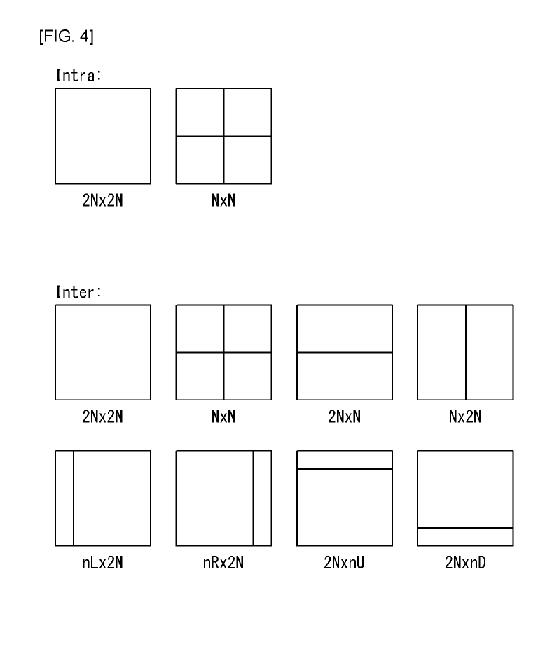

FIG. 4 is an embodiment to which the present invention is applied and is a diagram for illustrating a prediction unit.

A PU is differently partitioned depending on whether an intra-prediction mode or an inter-prediction mode is used as the coding mode of a CU to which the PU belongs.

FIG. 4(a) illustrates a PU in the case where the intra-prediction mode is used as the coding mode of a CU to which the PU belongs, and FIG. 4(b) illustrates a PU in the case where the inter-prediction mode is used as the coding mode of a CU to which the PU belongs.

Referring to FIG. 4(a), assuming the case where the size of one CU is 2N×2N (N=4, 8, 16 or 32), one CU may be partitioned into two types (i.e., 2N×2N and N×N).

In this case, if one CU is partitioned as a PU of the 2N×2N form, this means that only one PU is present within one CU.

In contrast, if one CU is partitioned as a PU of the N×N form, one CU is partitioned into four PUs and a different prediction block for each PU is generated. In this case, the partition of the PU may be performed only if the size of a CB for the luma component of a CU is a minimum size (i.e., if the CU is an SCU).

Referring to FIG. 4(b), assuming that the size of one CU is 2N×2N (N=4, 8, 16 or 32), one CU may be partitioned into eight PU types (i.e., 2N×2N, N×N, 2N×N, N×2N, nL×2N, nR×2N, 2N×nU and 2N×nD).

As in intra-prediction, the PU partition of the N×N form may be performed only if the size of a CB for the luma component of a CU is a minimum size (i.e., if the CU is an SCU).

In inter-prediction, the PU partition of the 2N×N form in which a PU is partitioned in a traverse direction and the PU partition of the N×2N form in which a PU is partitioned in a longitudinal direction are supported.

Furthermore, the PU partition of nL×2N, nR×2N, 2N×nU and 2N×nD forms, that is, asymmetric motion partition (AMP) forms, are supported. In this case, ‘n’ means a ¼ value of 2N. However, the AMP cannot be used if a CU to which a PU belongs is a CU of a minimum size.

In order to efficiently code an input image within one CTU, an optimum partition structure of a coding unit (CU), a prediction unit (PU) and a transform unit (TU) may be determined based on a minimum rate-distortion value through the following execution process. For example, an optimum CU partition process within a 64×64 CTU is described. A rate-distortion cost may be calculated through a partition process from a CU of a 64×64 size to a CU of an 8×8 size, and a detailed process thereof is as follows.

1) A partition structure of an optimum PU and TU which generates a minimum rate-distortion value is determined by performing inter/intra-prediction, transform/quantization and inverse quantization/inverse transform and entropy encoding on a CU of a 64×64 size.

2) The 64×64 CU is partitioned into four CUs of a 32×32 size, and an optimum partition structure of a PU and a TU which generates a minimum rate-distortion value for each of the 32×32 CUs is determined.

3) The 32×32 CU is partitioned into four CUs of a 16×16 size again, and an optimum partition structure of a PU and a TU which generates a minimum rate-distortion value for each of the 16×16 CUs is determined.

4) The 16×16 CU is partitioned into four CUs of an 8×8 size again, and an optimum partition structure of a PU and a TU which generates a minimum rate-distortion value for each of the 8×8 CUs is determined.

5) An optimum partition structure of a CU within a 16×16 block is determined by comparing the rate-distortion value of a 16×16 CU calculated in the process 3) with the sum of the rate-distortion values of the four 8×8 CUs calculated in the process 4). This process is performed on the remaining three 16×16 CUs in the same manner.

6) An optimum partition structure of a CU within a 32×32 block is determined by comparing the rate-distortion value of a 32×32 CU calculated in the process 2) with the sum of the rate-distortion values of the four 16×16 CUs calculated in the process 5). This process is performed on the remaining three 32×32 CUs in the same manner.

7) Finally, an optimum partition structure of a CU within a 64×64 block is determined by comparing the rate-distortion value of the 64×64 CU calculated in the process 1) with the sum of the rate-distortion values of the four 32×32 CUs obtained in the process 6).

In the intra-prediction mode, a prediction mode is selected in a PU unit and prediction and a reconfiguration are performed in an actual TU unit with respect to the selected prediction mode.

The TU means a basic unit by which actual prediction and a reconfiguration are performed. The TU includes a transform block (TB) for a luma component and a TB for two chroma components corresponding to the TB for a luma component.

In the example of FIG. 3, as in the case where one CTU is partitioned as a quadtree structure to generate a CU, a TU is hierarchically partitioned as a quadtree structure from one CU to be coded.

The TU is partitioned as a quadtree structure, and thus a TU partitioned from a CU may be partitioned into smaller lower TUs. In HEVC, the size of the TU may be determined to be any one of 32×32, 16×16, 8×8 and 4×4.

Referring back to FIG. 3, it is assumed that the root node of a quadtree is related to a CU. The quadtree is partitioned until a leaf node is reached, and the leaf node corresponds to a TU.

More specifically, a CU corresponds to a root node and has the smallest depth (i.e., depth=0) value. The CU may not be partitioned depending on the characteristics of an input image. In this case, a CU corresponds to a TU.

The CU may be partitioned in a quadtree form. As a result, lower nodes of a depth 1 (depth=1) are generated. Furthermore, a node (i.e., leaf node) that belongs to the lower nodes having the depth of 1 and that is no longer partitioned corresponds to a TU. For example, in FIG. 3(b), a TU(a), a TU(b) and a TU(j) corresponding to nodes a, b and j, respectively, have been once partitioned from the CU, and have the depth of 1.

At least any one of the nodes having the depth of 1 may be partitioned in a quadtree form again. As a result, lower nodes having a depth 2 (i.e., depth=2) are generated. Furthermore, a node (i.e., leaf node) that belongs to the lower nodes having the depth of 2 and that is no longer partitioned corresponds to a TU. For example, in FIG. 3(b), a TU(c), a TU(h) and a TU(i) corresponding to nodes c, h and i, respectively, have been twice partitioned from the CU, and have the depth of 2.

Furthermore, at least any one of the nodes having the depth of 2 may be partitioned in a quadtree form again. As a result, lower nodes having a depth 3 (i.e., depth=3) are generated. Furthermore, a node (i.e., leaf node) that belongs to the lower nodes having the depth of 3 and that is no longer partitioned corresponds to a CU. For example, in FIG. 3(b), a TU(d), a TU(e), a TU(f) and a TU(g) corresponding to nodes d, e, f and g, respectively, have been partitioned three times from the CU, and have the depth of 3.

A TU having a tree structure has predetermined maximum depth information (or the greatest level information) and may be hierarchically partitioned.

Furthermore, each partitioned TU may have depth information. The depth information may include information about the size of the TU because it indicates the partitioned number and/or degree of the TU.

Regarding one TU, information (e.g., a partition TU flag “split_transform_flag”) indicating whether a corresponding TU is partitioned may be transferred to the decoder. The partition information is included in all of TUs other than a TU of a minimum size. For example, if a value of the flag indicating whether a corresponding TU is partitioned is “1”, the corresponding TU is partitioned into four TUs again. If a value of the flag indicating whether a corresponding TU is partitioned is “0”, the corresponding TU is no longer partitioned.

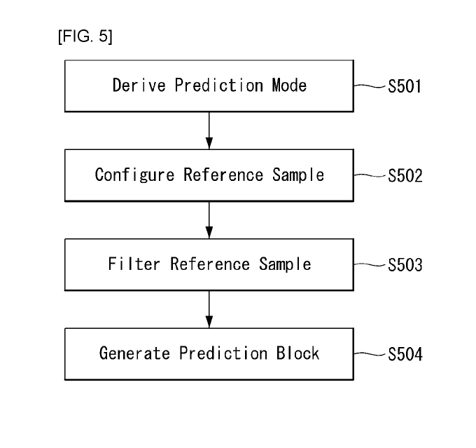

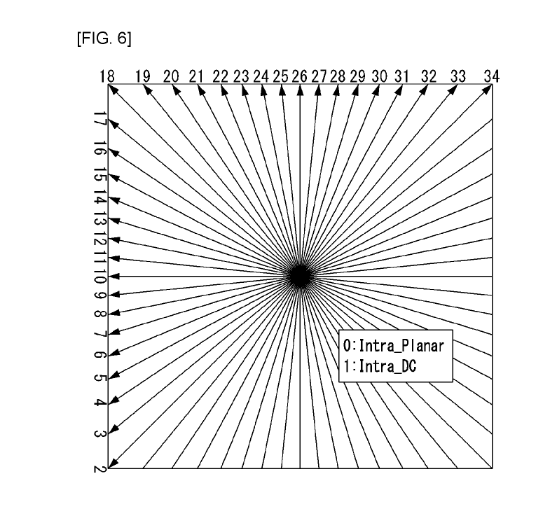

FIGS. 5 and 6 are embodiments to which the present invention is applied. FIG. 5 is a diagram for illustrating an intra-prediction method and FIG. 6 is a diagram for illustrating a prediction direction according to an intra-prediction mode.

Referring to FIG. 5, the decoder may derive the intra-prediction mode of a current processing block (S501).

In intra-prediction, a prediction direction for the location of a reference sample used for prediction may be included depending on a prediction mode. In this specification, an intra-prediction mode having a prediction direction is called an intra-direction prediction mode “Intra_Angular prediction mode” or an intra-direction mode. In contrast, an intra-prediction mode not having a prediction direction includes intra planar (INTRA_PLANAR) prediction mode and an intra DC (INTRA DC) prediction mode.

Table 1 illustrates names associated with the intra-prediction modes, and FIG. 6 illustrates prediction directions according to the intra-prediction modes.

TABLE 1

| INTRA- | |
|---|---|
| PREDICTION MODE | ASSOCIATED NAME |
| 0 | INTRA_PLANAR |
| 1 | INTRA_DC |
| 2 . . . 34 | Intra-direction (INTRA_ANGULAR2 . . . |
| | INTRA_ANGULAR34) |

In intra-prediction, prediction for a current processing block is performed based on a derived prediction mode. The reference sample and detailed prediction method used for prediction are different depending on the prediction mode. If a current block is encoded in the intra-prediction mode, the decoder may derive the prediction mode of the current block in order to perform prediction.

The decoder may check whether neighboring samples of the current processing block can be used for prediction and configure reference samples to be used for the prediction (S502).

In intra-prediction, neighboring samples of a current processing block mean a sample that neighbors the left boundary of the current processing block of an nS×nS size, a total of 2×nS samples that neighbor the bottom left, a sample that neighbors the top boundary of the current processing block, a total of 2×nS samples that neighbor the top right, and a sample that neighbors the top left of the current processing block.

However, some of the neighboring samples of the current processing block may have not been decoded or may not be available. In this case, the decoder may configure the reference samples to be used for prediction by substituting unavailable samples with available samples.

The decoder may filter the reference sample depending on an intra-prediction mode (S503).

Whether the filtering is to be performed on the reference sample may be determined based on the size of the current processing block. Furthermore, a method of filtering the reference sample may be determined by a filtering flag transferred by an encoder.

The decoder may generate a prediction block for the current processing block based on the intra-prediction mode and the reference samples (S504). That is, the decoder may generate the prediction block (i.e., generate the prediction sample) for the current processing block based on the intra-prediction mode derived in the intra-prediction mode derivation step S501 and the reference samples obtained through the reference sample configuration step S502 and the reference sample filtering step S503.

If the current processing block is encoded in the INTRA_DC mode, in order to minimize the discontinuity of the boundary between processing blocks, at step S504, the left boundary sample (i.e., a sample neighboring a left boundary within the prediction block) and top boundary sample (i.e., a sample neighboring a top boundary within the prediction block) of the prediction block may be filtered.

Furthermore, at step S504, filtering may be applied to the left boundary sample or the top boundary sample as in the INTRA_DC mode with respect to the vertical mode and horizontal mode of the intra-direction prediction modes.

More specifically, if the current processing block has been encoded in the vertical mode or horizontal mode, the value of a prediction sample may be derived based on a reference sample located in a prediction direction. In this case, a boundary sample that belongs to the left boundary sample or top boundary sample of the prediction block and that is not located in the prediction direction may neighbor a reference sample not used for prediction. That is, the distance from the reference sample not used for the prediction may be much shorter than the distance from a reference sample used for the prediction.

Accordingly, the decoder may adaptively apply filtering to left boundary samples or top boundary samples depending on whether an intra-prediction direction is the vertical direction or horizontal direction. That is, if the intra-prediction direction is the vertical direction, filtering may be applied to the left boundary samples. If the intra-prediction direction is the horizontal direction, filtering may be applied to the top boundary samples.

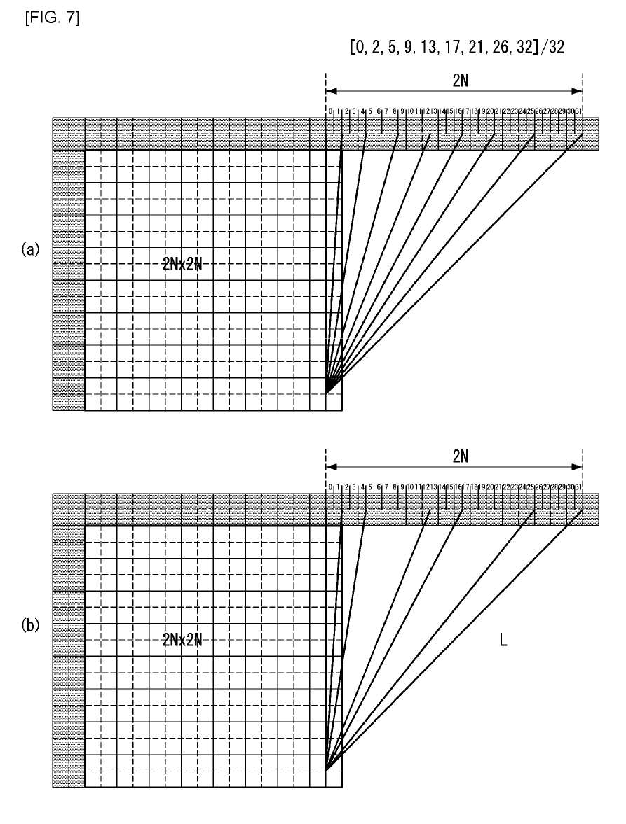

FIG. 7 is a diagram for describing a selection of mode adaptively in the case of 1/M degree of precision in the intra prediction mode, as an embodiment to which the present invention is applied.

In the intra prediction, a prediction direction has angles of +/−[0, 2, 5, 9, 13, 17, 21, 26 and 32]/32. The angles represent a difference between a lower row of a PU and an upper reference row of a PU in a vertical mode, and represent a difference between a right side column and a left reference column in a horizontal mode. In addition, by using a linear interpolation of upper or left reference samples of 1/32 pixel degree of accuracy.

According to the present invention, in the intra prediction, at least one of a mode number or a mode position may be adaptively selected. For example, according to FIG. 7 showing an embodiment to which the present invention is applied, in an intra vertical mode, the number L of modes that correspond to angles in the area corresponding to right 45° may be adaptively selected.

FIG. 7(a) shows an example that arbitrary eight modes having 1/32 degree of accuracy are selected with respect to the area 2N corresponding to right 45° in an intra vertical mode. FIG. 7(b) shows an example that L modes having 1/M degree of accuracy (e.g., M=32) are selected with respect to the area 2N corresponding to right 45° in an intra vertical mode.

The present invention proposes a method for adaptively selecting the mode number L in the intra prediction.

For example, the mode number L may de differently selected depending on the property of an image of the current block. In this case, the property of an image of the current block may be identified from neighboring reconstructed samples.

As the neighboring reconstructed samples, the reference sample (or reference array) used in the intra prediction may be used. For example, the reference sample may be the samples in the position of p(−1, −2N+1) p(−1,−1) p(2N−1, −1).

The property of an image may be determined by an upper reference array or a left reference array. However, the present invention is not limited to the upper reference array or the left reference array. For example, two lines of upper or left sample arrays or the more areas may also be used.

As another example, an encoder or a decoder to which the present invention is applied may determine the mode number L for the intra prediction as a minimum in the case that it is determined that the property of an image is homogeneous.

In addition, in the case that it is determined that the property of an image is not homogeneous, the mode number L may be determined to have various angular modes.

For example, as a method for determining whether the property of an image is homogenous, an edge examination and the like may be used. When it is determined that there is a strong edge in a specific part at an image examination, many angular modes may be allocated to the part intensively. Alternatively, various measurement methods for determining the property of an image may be used, for example, the information such as average of pixel values, dispersion, edge strength, an edge direction, and so on.

In addition, in the present invention, the position for each mode of L modes having 1/M degree of accuracy as well as the mode number may be adaptively selected.

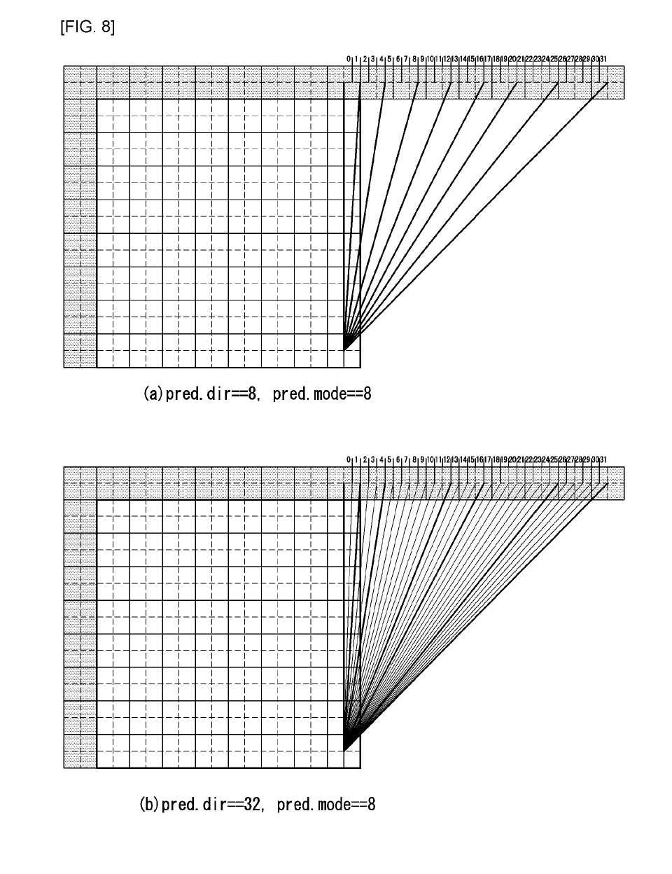

FIG. 8 is a diagram for describing the number of prediction directions and the number of modes in the intra prediction modes.

In the present invention, the number of prediction directions for performing a prediction and the number of modes transmitted may be independently determined. For example, it may be configured that the number of prediction directions is N and the number of transmission modes is N. Here, N should be greater than M.

That is, in the case of performing a prediction in the present invention, a prediction may be performed for all directions of N, but a transmission may be performed for the selected M modes.

For example, FIG. 8(a) shows the modes that correspond to right 45° among an intra vertical mode. Here, it has eight directions for right 45°, and the number of prediction directions is identical to the number of modes transmitted.

FIG. 8(b) shows that there are 32 prediction directions for right 45°, and there are 8 number of modes transmitted.

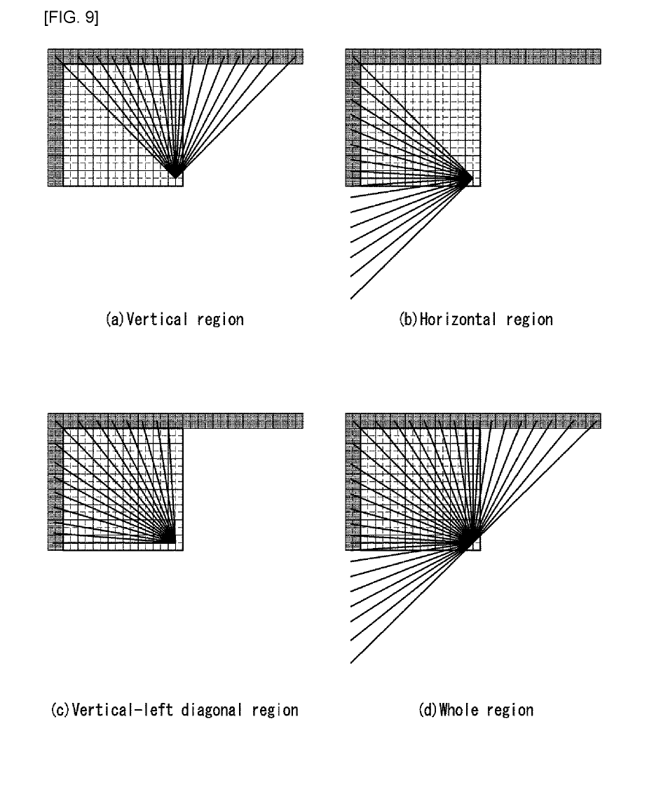

FIG. 9 illustrates various method of selection L modes based on a dominant direction in the intra prediction mode, as an embodiment to which the present invention is applied.

There is no overhead for L mode transmissions however 1/M degree of accuracy is minutely increased in the intra prediction mode. In this case, L may be greater or smaller than the number of prediction directions N. For example, a mode transmission may be performed with 1/64 degree of accuracy for right 45° only for selected 8 modes.

The present invention may provide various methods for selecting L modes based on a dominant direction in the intra prediction mode.

For example, the method of selecting L among N may be derived from context information. In this case, the context information may be at least one of the followings, but other methods may be used.

First, the context information may represent the dominant direction derived from an intra prediction direction of neighboring PUs (e.g., left PU, upper PU, etc.).

Second, the context information may represent the dominant direction derived from neighboring reconstructed samples.

Third, the context information may represent a degree of homogeneity derived from neighboring reconstructed samples.

Fourth, the context information may represent average or dispersion derived from neighboring reconstructed samples.

Fifth, the context information may represent angular information derived from neighboring reconstructed samples.

As another embodiment of the present invention, as shown in FIG. 9, a decoder may determine a dominant direction from neighboring reconstructed samples, and may select L modes based on the dominant direction. FIG. 9(a) shows the case that L modes are selected in a vertical area in the case that the dominant direction is the vertical direction, and FIG. 9(b) shows case that L modes are selected in a horizontal area in the case that the dominant direction is the horizontal direction. FIG. 9(c) shows the case that L modes are selected in a left diagonal area in the case that the dominant direction is a vertical-left diagonal direction, and FIG. 9(d) shows the case that L modes are selected in the vertical area in the case that the dominant direction is not clear or not existed and L modes are selected for all directions.

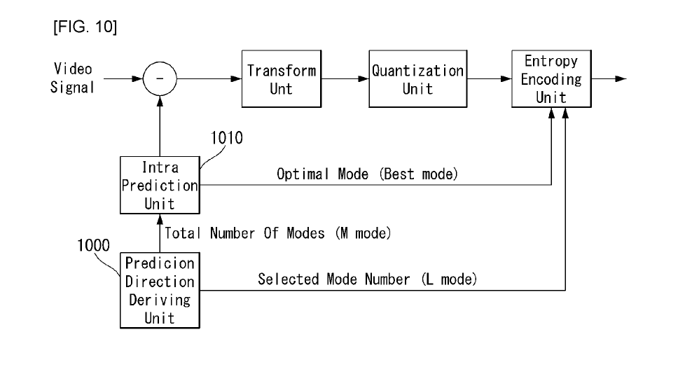

FIG. 10 is a schematic block diagram of an encoder that encodes an adaptively selected mode in the intra prediction, as an embodiment to which the present invention is applied.

The encoder to which the present invention is applied shows the block diagram of the encoder shown in FIG. 1 schematically, and the functions of the parts to which the present invention is applied are focused and described. The encoder may include a prediction direction deriving unit 1000 and an intra prediction unit 1010.

When the encoder performs the intra prediction, the prediction direction deriving unit 1000 may determine a dominant direction based on the information of a neighboring block. In this case, the dominant direction may be determined the embodiments described in FIG. 9.

In addition, L modes may be selected based on the dominant direction of the neighboring block. The prediction direction deriving unit 1000 may transmit the selected L modes to an entropy encoding unit, and may transmit the total number M of the intra prediction modes to the intra prediction unit 1010.

The intra prediction unit 1010 may determine an optimal prediction mode among the M intra prediction modes transmitted from the prediction direction deriving unit 1000. The determined optimal prediction mode may be transmitted to the entropy encoding unit.

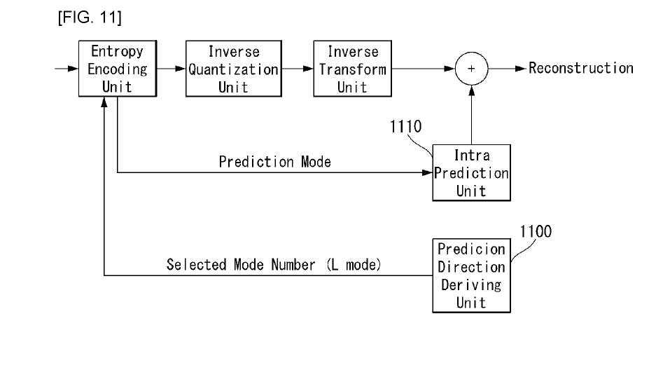

FIG. 11 illustrates a schematic block diagram of a decoder for decoding a mode adaptively selected in the intra prediction, as an embodiment to which the present invention is applied.

The decoder to which the present invention is applied schematically shows the decoder block diagram of FIG. 2, and the functions of the parts to which the present invention is applied are focused and described. The decoder may include a prediction direction deriving unit 1100 and an intra prediction unit 1110.

The prediction direction deriving unit 1100 may transmit the selected L numbers of intra prediction modes to an entropy decoding unit, and the entropy decoding unit may perform an entropy decoding based on the selected mode number L.

In addition, the entropy decoding unit may receive a video signal, and may transmit the intra prediction mode among them to the intra prediction unit 1110.

The intra prediction unit 1110 may perform an intra prediction by receiving the intra prediction mode. The predicted value outputted through the intra prediction may reconstruct the video signal by being added to the residual value passing through the inverse quantization and the inverse transform.

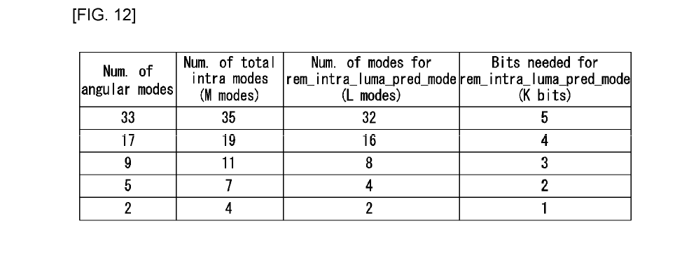

FIG. 12 illustrates various methods for the L numbers of intra prediction modes selected based on the dominant direction, as an embodiment to which the present invention is applied.

As an embodiment, when it is determined that there is no dominant prediction direction with respect to the current block based on neighboring block information, the number L of modes transmitted by rem_intra_luma_pred_mode may be set to 32, and the bit number required to coding it is 5 bits. In this case, the total number M of the intra modes may be 35 including a DC mode and a PLANAR mode.

As another embodiment, when the number of modes selected based on the dominant direction is 16, the number L of modes transmitted by rem_intra_luma_pred_mode may be set to 16, and the bit number required to coding it is 4 bits.

As another embodiment, when the number of modes selected based on the dominant direction is 8, the number L of modes transmitted by rem_intra_luma_pred_mode may be set to 8, and the bit number required to coding it is 3 bits.

As another embodiment, when the number of modes selected based on the dominant direction is 4, the number L of modes transmitted by rem_intra_luma_pred_mode may be set to 4, and the bit number required to coding it is 2 bits.

As another embodiment, when the number of modes selected based on the dominant direction is 2, the number L of modes transmitted by rem_intra_luma_pred_mode may be set to 2, and the bit number required to coding it is 1 bit.

As described above, based on the dominant direction, the number of modes to transmit actually is selected, thereby decreasing a bit number.

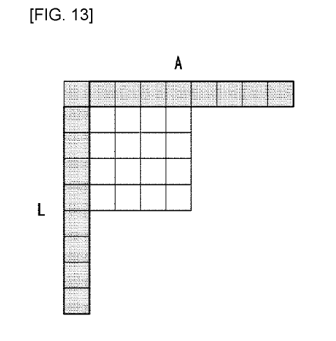

FIG. 13 is a diagram for describing a method of selecting the dominant direction using a neighboring sample, as an embodiment to which the present invention is applied.

According to the present invention, the dominant direction may be determined from the information of a neighboring block. For example, as the information of the neighboring block, the sample value of the neighboring block may be used.

Referring to FIG. 13, by checking whether there is an edge from at least one sample among area A and area B, the dominant direction may be determined. In this case, whether there is an edge may be determined by identifying whether a variance value of the sample values of the area A and area B is smaller than a specific threshold value. For example, in the case that the variance value of the sample values of the area A and area B is smaller than a specific threshold value, it may be determined that there exist an edge.

As another embodiment, in the case that an edge is detected in area A and an edge is not detected in area B, 17 modes of area A may be used only, and the mode of area B may not be used. In this case, it may be that total number of modes is M=19 (=17+2), the transmitted numbers of mode L=16, and the bit number K=4.

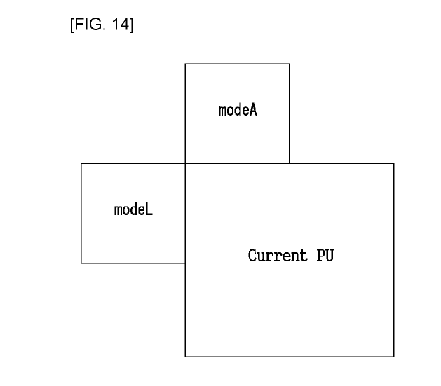

FIG. 14 is a diagram for describing a method of selecting the dominant direction using neighboring mode information, as an embodiment to which the present invention is applied.

According to the present invention, the dominant direction may be determined from the information of a neighboring block. For example, as the information of the neighboring block, the intra mode information of the neighboring block may be used.

Referring to FIG. 14, the dominant direction may be determined by comparing the intra mode information of an upper block and a left block. For example, in the case that the mode information (mode A) of the upper block is the same as the mode information (mode B) of the left block, only 5 mode may be used including mode A and the two modes of left and right sides, respectively.

In this case, it may be that total number of modes is M=7, the transmitted numbers of mode L=4, and the bit number K=2.

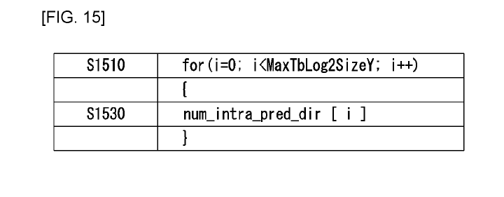

FIG. 15 illustrates a syntax structure for transmitting the number of prediction directions, as an embodiment to which the present invention is applied.

The present invention provides a method for signaling the number of prediction directions. The present invention is described based on 45° under the assumption that the number of prediction directions may be identically applied to other 45° area. However, this is an assumption for intuitive description, and the present invention is not limited thereto. Accordingly, the description in relation to the prediction direction included in the present specification may also be applied to the case of all areas in addition to 45°.

The number of prediction directions may be transmitted in at least one level of an SPS, a PPS or a slice header. In this case, the number of prediction directions may be defined by “num_intra_pred_dir” syntax.

In addition, different number of prediction directions may be transmitted for each block size (e.g., TU or PU) for prediction. For example, in the case of for(i=0; i<MaxTbLog2SizeY; i++) (step, S1510), the number of prediction directions num_intra_pred_dir [i] may be transmitted for each block size (step, S1530).

As another embodiment of the present invention, the number of prediction directions may be derived from a specific parameter. For example, the number of prediction directions may be derived from a quantization parameter. For a lower quantization parameter, the more number of prediction directions may be defined, and for a higher quantization parameter, the less number of prediction directions may be defined.

As another embodiment of the present invention, the number of prediction directions may be derived from resolution information. For example, for an image of higher resolution, the more number of prediction directions may be defined, and for an image of lower resolution, the less number of prediction directions may be defined. Or, the opposite case may be applied.

As another embodiment of the present invention, the number of prediction directions may be derived from a profile or level information, and may be differently configured according to context information for each TU or PU.

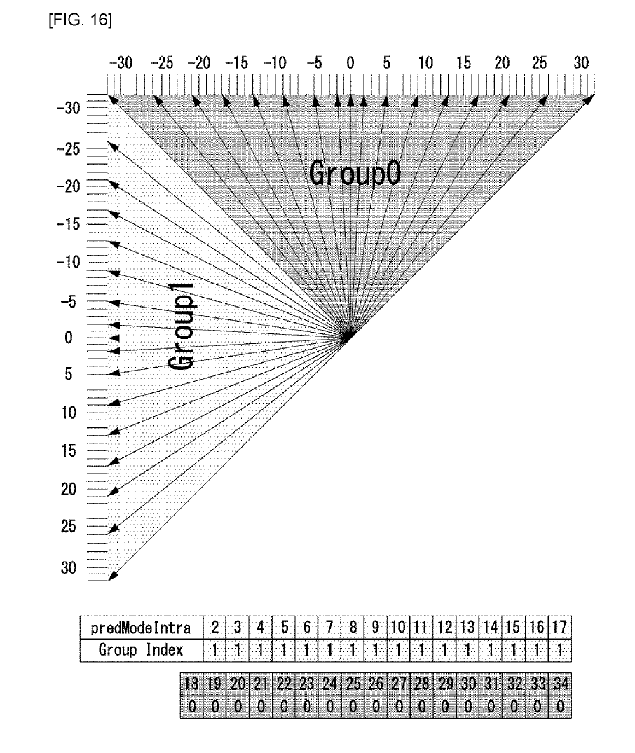

FIG. 16 is a diagram for describing a method for configuring a group index with respect to an intra prediction mode, as an embodiment to which the present invention is applied.

According to the present invention, a group index may be configured for an intra prediction mode.

Referring to FIG. 16, as an embodiment of the present invention, with respect to 33 intra angular modes, either one group index of 0 and 1 may be allocated. For example, for the vertical modes belonged to a vertical direction, the group index is configured as 0, and for the horizontal modes belonged to a horizontal direction, the group index is configured as 1.

In addition, the number of intra angular modes is not limited to 33 in the present invention, but any of M modes may be the number of intra angular modes. Furthermore, the number of groups is not limited to 2, and N groups may be configured.

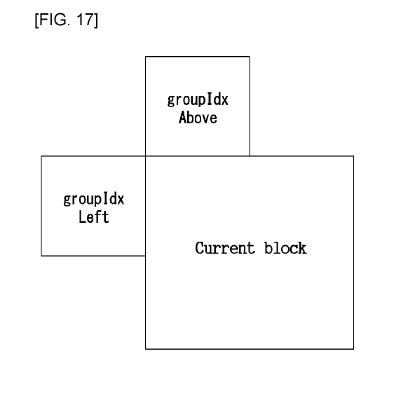

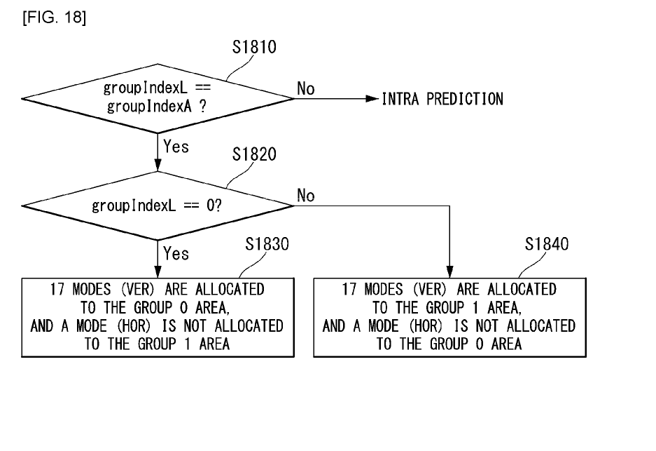

FIGS. 17 and 18 are diagrams for describing a method for determining a dominant prediction direction based on a group index of a neighboring block, as an embodiment to which the present invention is applied.

According to the present invention, based on a group index of a neighboring block, the dominant prediction direction may be determined.

For example, by identifying a group index of a left block and an upper block of a target block to predict, the dominant direction may be determined.

Referring to FIG. 17, the group index of the left block may be referred to as groupIdxLeft and the group index of the upper block may be referred to as groupIdxAbove.

According to the present invention, it may be determined whether the group indexes of the left block and the upper block are identical (step, S1810). In this case, it is assumed that the number of intra angular modes is M (e.g., M=33).

In the case that the group indexes of the left block and the upper block are identical, M modes may be concentrated on the area corresponding to the group index. For example, when the group index is 0, the vertical mode may be allocated, and when the group index is 1, the horizontal mode may be allocated. Meanwhile, in the case that group indexes of the left block and the upper block are not identical, M modes may be homogeneously distributed through the entire areas.

For example, in the case that the group indexes of the left block and the upper block are identical, by determining whether group index of the left block or the upper block is 0 or 1, the dominant direction may be determined (step, S1820). On the contrary, in the case that group indexes of the left block and the upper block are not identical, the intra prediction may be performed according to the conventional method.

In addition, in the case that the group indexes of the left block is 0, 17 vertical modes may be allocated to the group 0 area, and a mode may not be allocated to the group 1 area (step, S1830).

On the other hand, in the case that the group indexes of the left block is not 0, 17 vertical modes may be allocated to the group 1 area, and a mode may not be allocated to the group 0 area (step, S1840).

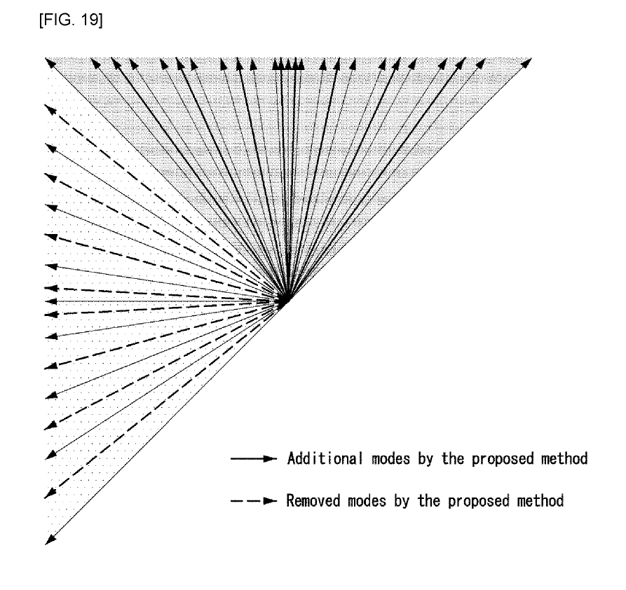

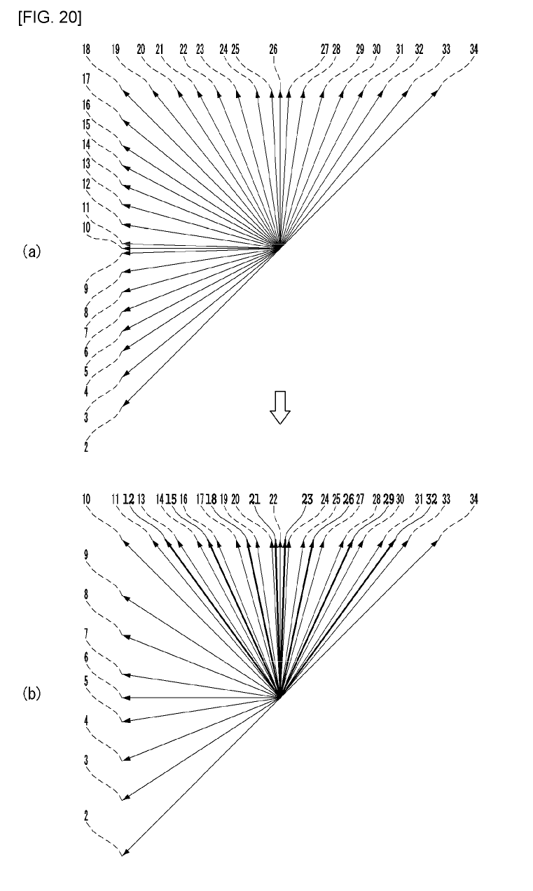

FIGS. 19 and 20 are flowcharts for describing a method for allocating a prediction mode based on a group index of a neighboring block, as an embodiment to which the present invention is applied.

According to the present invention, when neighboring blocks have the same prediction direction, under the assumption that a current block is highly probable to have the same direction, the only corresponding prediction direction may be allowed and the opposite prediction direction may not be allowed. Referring to FIG. 19, in the case that all of the neighboring blocks are in a vertical mode, the current block may remove a part of angular modes in a horizontal direction and may allocate an angular mode in a vertical direction additionally.

As another example, FIG. 19 may show the case that the group indexes of a left block and an upper block are the same, and all of the group indexes are 0.

FIG. 20 represents the comparison of above case. FIG. 20(a) shows the angular prediction mode before change and FIG. 20(b) shows the case that a part of angular modes in a horizontal direction is removed and an angular mode in a vertical direction is additionally allocated. In this case, the number of modes which is removed may be identical to the number of modes which is added, but the present invention is not limited thereto.

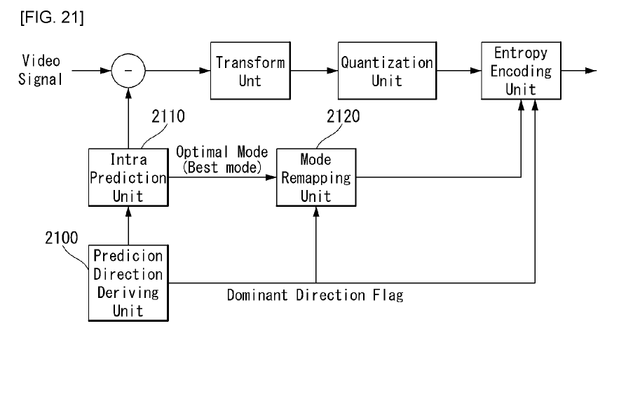

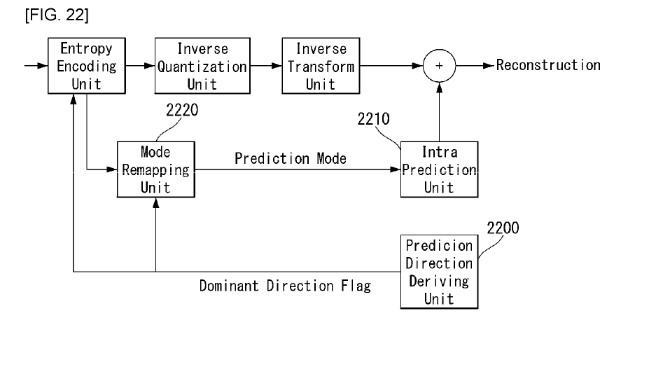

FIGS. 21 and 22 are schematic block diagrams of an encoder and a decoder for remapping a mode according to a dominant direction flag, as an embodiment to which the present invention is applied.

Referring to FIG. 21, the encoder to which the present invention is applied may include a prediction direction deriving unit 2100, an intra prediction unit 2110 and a mode remapping unit 2120. The encoder may include other functional units shown in FIG. 1, but only the units required for describing an embodiment of the present invention are briefly depicted.

When the encoder performs an intra prediction, the prediction direction deriving unit 2100 may determine a dominant direction based on the information of neighboring blocks. In this case, the dominant direction may be determined according to the embodiments described in the present specification.

In addition, the prediction direction deriving unit 2100 may derive a dominant direction flag. In this case, the dominant direction flag may mean the flag information representing whether the dominant direction for an intra prediction of a current block is existed. For example, the dominant direction flag may be represented as ‘hasDomDirFlag’. For example, when ‘hasDomDirFlag’=0, it may mean that there is no dominant direction for the intra prediction of the current block, and when ‘hasDomDirFlag’=1, it may mean that there exists a dominant direction for the intra prediction of the current block.

As another example, the dominant direction flag may mean the information representing where the direction of the dominant direction is. For example, when ‘hasDomDirFlag’=0, it may mean that the dominant direction for the intra prediction of the current block is a horizontal direction, and when ‘hasDomDirFlag’=1, it may mean that the dominant direction for the intra prediction of the current block is a vertical direction. This is just an example, and the dominant direction flag may be defined as a value that represents 3 or more directions.

Meanwhile, the prediction direction deriving unit 2100 may select L modes based on a dominant direction of a neighboring block. The prediction direction deriving unit 2100 may transmit the selected L modes to an entropy encoding unit, and may transmit total number M of intra prediction modes to the intra prediction unit 2110.

The intra prediction unit 2110 may determine an optimal prediction mode among the M intra prediction modes transmitted from the prediction direction deriving unit 2100. The determined optimal prediction mode may be transmitted to the mode remapping unit 2120.

The mode remapping unit 2120 may remap the optimal prediction mode based on the dominant direction flag.

As an embodiment, in the case that there exists a dominant direction for the intra prediction of the current block according to the dominant direction flag, the optimal prediction mode value may be subtracted by a specific value, and may be remapped to smaller value. In this case, the specific value may be a value in relation to the number of vertical directions or horizontal directions of the intra prediction mode or a value in relation to the total number of the intra prediction mode. On the contrary, in the case that there is no dominant direction for the intra prediction of the current block according to the dominant direction flag, the determined optimal prediction mode may not be remapped and may be coded without any change.

As another embodiment, in the case that the dominant direction for the intra prediction of the current block according to the dominant direction flag represents a vertical direction, the optimal prediction mode value may be subtracted by a specific value, and may be remapped to smaller value. In this case, the specific value may be a value in relation to the number of vertical directions or horizontal directions of the intra prediction mode or a value in relation to the total number of the intra prediction mode. For example, the specific value may be 16.

The intra prediction mode remapped through the mode remapping unit 2120 may be transmitted to the entropy encoding unit and performed through an entropy encoding. In this case, the remapped intra prediction mode may be coded to smaller bit.

Meanwhile, as an embodiment of the present invention, an encoder may determine a dominant prediction direction of a current block based on group index information of a neighboring block. For example, when both of the group indexes of a left block and an upper block are 0, shorter bit may be allocated to the modes in a vertical direction and relatively longer bit may be allocated to the modes in a horizontal direction. In addition, when both of the group indexes of a left block and an upper block are 1, shorter bit may be allocated to the modes in a horizontal direction and relatively longer bit may be allocated to the modes in a vertical direction.

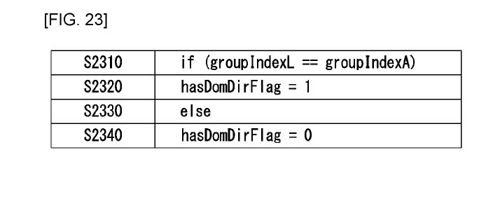

As another embodiment of the present invention, the mode remapping unit 2120 may remap an optimal prediction mode based on at least one of the dominant direction flag and the group index information of a neighboring block. The detailed embodiments are described in detail with reference to FIG. 23 to FIG. 25.

Referring to FIG. 22, the decoder to which the present invention is applied may include a prediction direction deriving unit 2200, an intra prediction unit 2210 and a mode remapping unit 2220. The decoder may include other functional units shown in FIG. 2, but only the units required for describing an embodiment of the present invention are briefly depicted.

The prediction direction deriving unit 2200 and the intra prediction unit 2210 may be performed in the similar way as the functional units described in FIG. 21.

The mode remapping unit 2220 may receive a prediction mode. In this case, the prediction mode may be transmitted from an encoder, and the received prediction mode may be performed through entropy decoding through an entropy decoding unit and transmitted to the mode remapping unit 2220.

The mode remapping unit 2220 may remap the received prediction mode based on a dominant direction flag. In this case, the prediction mode may be remapped by being added by a specific value.

For example, in the case that the dominant direction for the intra prediction of the current block according to the dominant direction flag represents a vertical direction, the prediction mode may be remapped to an original prediction mode value by adding a specific value to the transmitted prediction mode value. In this case, the specific value may be a value in relation to the number of vertical directions or horizontal directions of the intra prediction mode or a value in relation to the total number of the intra prediction mode. For example, the specific value may be 16.

The prediction mode remapped as such may be transmitted to the intra prediction unit 2210 and may perform an intra prediction.

FIG. 23 illustrates a syntax structure for configuring a dominant direction flag based on a group index of a neighboring block, as an embodiment to which the present invention is applied.

In the embodiment of the present invention, the dominant direction flag may mean the information representing where the direction of the dominant direction is. For example, when ‘hasDomDirFlag’=0, it may mean that the dominant direction for the intra prediction of the current block is a horizontal direction, and when ‘hasDomDirFlag’=1, it may mean that the dominant direction for the intra prediction of the current block is a vertical direction. This is just an example, and the dominant direction flag may be defined as a value that represents 3 or more directions.

According to the present invention, a dominant direction flag may be determined or derived based on a group index of a neighboring block. For example, the dominant direction flag may be determined by checking group indexes of a left block and an upper block of a target block to predict.

Assuming that the group index of the left block is groupindexL and the group index of the upper block is groupindexA, it may be determined whether the group indexes of the left block and the upper block are identical according to the present invention.

In the case that the group indexes of the left block and the upper block are identical (step, S2310), the dominant direction flag hasDomDirFlag may be determined to be 1 (step, S2320).

On the contrary, in the case that the group indexes of the left block and the upper block are not identical (step, S2330), the dominant direction flag hasDomDirFlag may be determined to be 0 (step, S2340).

In this case, the dominant direction flag hasDomDirFlag may be applied to all embodiments described in the present specification.

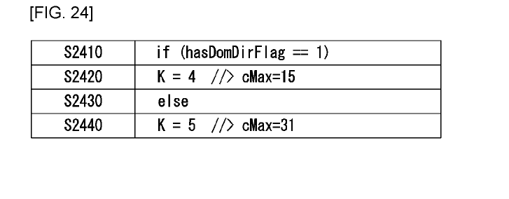

FIG. 24 illustrates a syntax structure for deriving a bit number with respect to mode information based on a dominant direction flag, as an embodiment to which the present invention is applied.

According to the present invention, based on the dominant direction flag, an optimal prediction mode which is remapped may be performed through entropy encoding.

As an embodiment, in the case that the dominant direction for an intra prediction of a current block represents a vertical direction according to the dominant direction flag (step, S2410), the optimal prediction mode value may be subtracted by a specific value, and may be remapped to smaller value. In this it may be coded with the smaller bits than the previous case. For example, in the case that 5 bits are required for coding a prediction mode, it may be available to perform coding with 4 bits (step, S2420).

On the contrary, in the case that the dominant direction for an intra prediction of a current block represents a vertical direction according to the dominant direction flag (step, S2430), the optimal prediction mode value may be coded without any change. For example, in the case that 5 bits are required for coding a prediction mode, it may be available to perform coding with 5 bits (step, S2440).

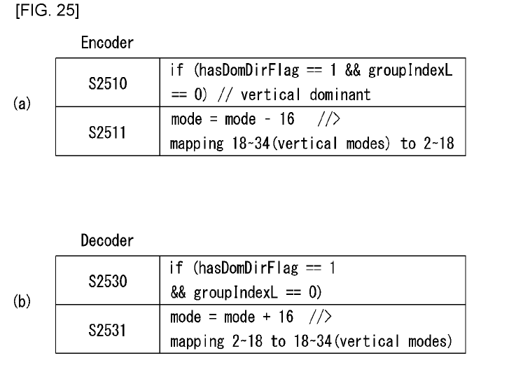

FIG. 25 illustrates a syntax structure for remapping a mode based on at least one of a dominant direction flag and a group index, as an embodiment to which the present invention is applied.

As an embodiment of the present invention, a mode remapping unit of an encoder may remap an optimal prediction mode based on at least one of the dominant direction flag and the group index information of a neighboring block.

For example, when both of the dominant direction flag and the group index represent a vertical direction, a mode value may be remapped by subtracting a specific value from a prediction mode of a current block. As a particular example, in the case that the dominant direction flag represents that a dominant direction for an intra prediction of the current block is a vertical direction (hasDomDirFlag=1) and the group index of a left block represents a vertical direction mode (groupindexL=0) (step, S2510), the prediction mode value may be remapped by subtracting 16 from the prediction mode value of the current block (mode=mode−16) (step, S2511).

As another embodiment of the present invention, a mode remapping unit of a decoder may remap an optimal prediction mode based on at least one of the dominant direction flag and the group index information of a neighboring block.

For example, when both of the dominant direction flag and the group index represent a vertical direction, a mode value may be remapped by subtracting a specific value from a prediction mode of a current block. As a particular example, in the case that the dominant direction flag represents that a dominant direction for an intra prediction of the current block is a vertical direction (hasDomDirFlag=1) and the group index of a left block represents a vertical direction mode (groupindexL=0) (step, S2530), the prediction mode value may be remapped by adding 16 from the prediction mode value of the current block (mode=mode+16) (step, S2531).

As described above, the embodiments described in the present invention may be performed by being implemented on a processor, a microprocessor, a controller or a chip. For example, the functional units depicted in FIG. 1, FIG. 2, FIG. 10, FIG. 11, FIG. 21 and FIG. 22 may be performed by being implemented on a computer, a processor, a microprocessor, a controller or a chip.

As described above, the decoder and the encoder to which the present invention is applied may be included in a multimedia broadcasting transmission/reception apparatus, a mobile communication terminal, a home cinema video apparatus, a digital cinema video apparatus, a surveillance camera, a video chatting apparatus, a real-time communication apparatus, such as video communication, a mobile streaming apparatus, a storage medium, a camcorder, a VoD service providing apparatus, an Internet streaming service providing apparatus, a three-dimensional 3D video apparatus, a teleconference video apparatus, and a medical video apparatus and may be used to code video signals and data signals.

Furthermore, the decoding/encoding method to which the present invention is applied may be produced in the form of a program that is to be executed by a computer and may be stored in a computer-readable recording medium. Multimedia data having a data structure according to the present invention may also be stored in computer-readable recording media. The computer-readable recording media include all types of storage devices in which data readable by a computer system is stored. The computer-readable recording media may include a BD, a USB, ROM, RAM, CD-ROM, a magnetic tape, a floppy disk, and an optical data storage device, for example. Furthermore, the computer-readable recording media includes media implemented in the form of carrier waves, e.g., transmission through the Internet. Furthermore, a bit stream generated by the encoding method may be stored in a computer-readable recording medium or may be transmitted over wired/wireless communication networks.

### INDUSTRIAL APPLICABILITY

The exemplary embodiments of the present invention have been disclosed for illustrative purposes, and those skilled in the art may improve, change, replace, or add various other embodiments within the technical spirit and scope of the present invention disclosed in the attached claims.

1-8. (canceled)

9. A method for decoding a video signal, comprising:
determining a dominant prediction direction of a current block using information of a neighboring block;
deriving a variable representing whether the dominant prediction direction is existed;
remapping an intra prediction mode extracted from the video signal based on the variable; and
generating a prediction signal according to the remapped intra prediction mode.

10. The method of claim 9, further comprising
obtaining the information of the neighboring block,
wherein the information of the neighboring block includes at least one of group index information, an intra prediction mode or edge information.

11. The method of claim 10, further comprising
checking whether group index information of the neighboring block is identical,
wherein the dominant prediction direction is determined according to the group index information of the neighboring block, and
wherein the neighboring block includes a left block and an upper block neighboring to the current block.

12. The method of claim 10, further comprising
checking whether the intra prediction mode of the neighboring block is identical,
wherein the dominant prediction direction is determined according to the intra prediction mode of the neighboring block, and
wherein the neighboring block includes a left block and an upper block neighboring to the current block.

13. The method of claim 10, further comprising
checking whether the edge information of the neighboring block is detected,
wherein the dominant prediction direction is determined according to the edge information of the neighboring block, and
wherein the neighboring block includes a left block and an upper block neighboring to the current block.

14. (canceled)

15. An apparatus for encoding a video signal, comprising:
a prediction direction deriving unit configured to determine a dominant prediction direction of a current block using information of a neighboring block, and to determine a number of intra prediction modes to transmit based on the dominant prediction direction; and
an intra prediction unit configured to determine an optimal intra prediction mode based on the number of intra prediction modes, and to generate a prediction signal according to the optimal intra prediction mode.

16. The apparatus of claim 15,
wherein the prediction direction deriving unit obtains the information of the neighboring block, and
wherein the information of the neighboring block includes at least one of group index information, an intra prediction mode or edge information.

17. The apparatus of claim 16,
wherein the prediction direction deriving unit checks whether group index information of the neighboring block is identical, and
wherein the dominant prediction direction is determined according to the group index information of the neighboring block.

18. The apparatus of claim 16,
wherein the prediction direction deriving unit checks whether the intra prediction mode of the neighboring block is identical, and
wherein the dominant prediction direction is determined according to the intra prediction mode of the neighboring block.

19. The apparatus of claim 16,
wherein the prediction direction deriving unit checks whether the edge information of the neighboring block is detected, and
wherein the dominant prediction direction is determined according to the edge information of the neighboring block.

20. The apparatus of claim 15,
wherein the prediction direction deriving unit derives a variable representing whether the dominant prediction direction is existed, and
wherein the apparatus further comprises a mode remapping unit configured to remap the optimal intra prediction mode based on the variable.

21. The apparatus of claim 18,
wherein the information of the neighboring block includes at least one of group index information, an intra prediction mode or edge information, and
wherein the optimal intra prediction mode is remapped based on the group index information and the variable.

22. An apparatus for decoding a video signal, comprising:
a prediction direction deriving unit configured to determine a dominant prediction direction of a current block using information of a neighboring block, and to derive a variable representing whether the dominant prediction direction is existed;
a mode remapping unit configured to remap an intra prediction mode extracted from the video signal based on the variable; and
an intra prediction unit configured to generate a prediction signal according to the remapped intra prediction mode.

23. The apparatus of claim 22,
wherein the prediction direction deriving unit obtains the information of the neighboring block, and
wherein the information of the neighboring block includes at least one of group index information, an intra prediction mode or edge information.

24. The apparatus of claim 23,
wherein the prediction direction deriving unit checks whether group index information of the neighboring block is identical,
wherein the dominant prediction direction is determined according to the group index information of the neighboring block, and
wherein the neighboring block includes a left block and an upper block neighboring to the current block.

25. The apparatus of claim 23,
wherein the prediction direction deriving unit checks whether the intra prediction mode of the neighboring block is identical,
wherein the dominant prediction direction is determined according to the intra prediction mode of the neighboring block, and
wherein the neighboring block includes a left block and an upper block neighboring to the current block.

26. The apparatus of claim 23,
wherein the prediction direction deriving unit checks whether the edge information of the neighboring block is detected,
wherein the dominant prediction direction is determined according to the edge information of the neighboring block, and
wherein the neighboring block includes a left block and an upper block neighboring to the current block.
